(19) United States
(12) Patent Application Publication
(10) Pub. No.: US 2015/0230474 A1
(43) Pub. Date: Aug. 20, 2015

(54) Use of Glyphosate to Control Clubroot Disease

(71) Applicants: Yangdou Wei, Saskatoon (CA); Cindy Zou, Miami, FL (US)

(72) Inventors: Yangdou Wei, Saskatoon (CA); Cindy Zou, Miami, FL (US)

(21) Appl. No.: 14/622,889

(22) Filed: Feb. 15, 2015

(30) Foreign Application Priority Data
Feb. 19, 2014 (CA) 2843032

(51) Int. Cl. A01N 57/20

(52) U.S. Cl. CPC A01N 57/20

(57) ABSTRACT

A method of treating a plant growth medium comprising applying a glyphosate pesticide to the plant growth medium. The treatment may prevent, inhibit, reduce and/or treat clubroot disease, caused by infection with Plasmodiophora brassicae, in one or more plants grown in the plant growth medium. Further provided is use of a glyphosate pesticide to treat a plant growth medium in order to prevent or treat clubroot disease in one or more plants grown in the plant growth medium. Additionally provided is a glyphosate pesticide for use to treat a plant growth medium in order to prevent or treat clubroot disease in one or more plants grown in the plant growth medium. Also provided is a method of treating a piece of agricultural equipment with a glyphosate pesticide.

### BACKGROUND OF THE INVENTION

1. Field of the Invention

The disclosure relates generally to the field of plant disease control and more particularly to the control of clubroot disease, a soil-borne disease affecting plants belonging to the genus Brassicaceae, that is caused by Plasmodiophora brassicae.

2. Description of the Related Art

Clubroot disease is a soil-borne disease affecting plants in the genus Brassicaceae, also referred to as the brassica family, which is caused by the protistan pathogen Plasmodiophora brassicae. Other non-brassica plants, such as Dactylis glomerata, Fragaria spp., and Lolium perenne are also susceptible to infection by Plasmodiophora brassicae, but the role of these plants in the cycle of the disease is not well understood. The brassica family includes commercially important crops such as canola, rapeseed, mustard, cabbage, cauliflower, and broccoli.

Clubroot infection of brassica plants can lead to substantially reduced yields, resulting in corresponding economic losses. Symptoms of clubroot disease include premature crop ripening, yellowing, wilting, stunting, and galls on the roots of infected plants. On a worldwide scale, incidences of clubroot disease in brassica plants have been estimated at greater than 10% (Crete 1981) and estimates of financial losses in fields with significant clubroot infestations have been estimated at about 50% of overall returns (Dixon 2009).

Clubroot disease spreads very easily through soil transfer, for example on machinery or livestock, or by wind. Further, Plasmodiophora brassicae spores are very long-lived and can survive in soil for fifteen years or more, even in the absence of a susceptible host (Wallenhammar 1996). As a result, Plasmodiophora brassicae spreads easily and is difficult to control through crop rotations. The primary control measure for clubroot disease is the prevention of spread of the disease through careful land management and sanitation procedures. Once clubroot disease becomes established in a growing area, effective control measures are limited.

Field observations have shown that clubroot disease typically develops in soils with a pH lower than 7.1 (Myers and Campbell, 1985). As a result, soil amendment with pH-increasing agents such as lime and wood ash has become an important clubroot management strategy. However, large or repeated applications may reduce nutrient availability and the application of these amendments is not consistent over different soil types. Further, the quantities needed to amend the soil over large areas are prohibitive to widespread use. Mineral nutrients such as calcium, boron, and nitrogen have also shown some potential for reducing clubroot levels, however high levels of application may lead to phytotoxicity.

Clubroot disease is well established in brassica vegetable growing regions, particularly in the United Kingdom, where average infection rates have been estimated to be as high as 45-48% (Crete 1981). Since 2003, clubroot disease has become prevalent in canola crops. Worldwide, canola and rapeseed production was 61 million metric tons in 2011, representing approximately 13% of world oilseed production. Canada is among the top canola producers in the world, with canola production in the Prairie Provinces reported at 6,343,400 hectares in 2009 (Howard et al 2009). Many commercial cultivars of canola are highly susceptible to clubroot disease (Strelkov et al 2006). Clubroot resistant canola varieties became available in 2009, however the sources of genetic resistance are limited (Hirai 2006; Diederichsen et al 2009) and resistance can be quickly eroded (Oxley 2007).

Clubroot disease is a widespread problem for brassica crops and is becoming increasingly prevalent in canola crops. Canola is a major global crop and was the second largest global oil crop in 2008/2009. Any significant development of clubroot disease among canola crops in major canola-producing regions would have profound economic effects. Clubroot disease is a difficult disease to manage and there is a strong desire for effective control measures.

### SUMMARY OF THE INVENTION

A first embodiment is a method for treating a plant growth medium, said method comprising applying a glyphosate pesticide to said plant growth medium in order to prevent, inhibit, reduce, or treat clubroot disease in one or more plants grown in said plant growth medium.

In an embodiment of the method, the glyphosate pesticide comprises a solution comprising glyphosate, a glyphosate salt, and/or a derivative of glyphosate that inhibits enzyme 5-enolpyruvylshikimate-3-phosphate synthase (EPSP synthase).

In a further embodiment of the method, the solution comprises the glyphosate, the glyphosate salt, and/or the glyphosate derivative at a total concentration of between about 0.4 mg/ml and about 2.0 mg/ml, between about 0.8 mg/ml and about 1.7 mg/ml, or between 0.82 mg/ml and 1.63 mg/ml.

In another embodiment of the method, the application of the solution to the plant growth medium is carried out by drench application.

In an embodiment of the method, the glyphosate pesticide is applied to the plant growth medium at an application rate of between about 0.18 g to about 1 g total of glyphosate, glyphosate salt, and/or glyphosate derivative per liter of plant growth medium.

In yet another embodiment of the method, the glyphosate pesticide is applied to the plant growth medium at a surface application rate of between about 10 g to about 50 g total of glyphosate, glyphosate salt, and/or glyphosate derivative per m² of plant growth medium.

In an embodiment of the method, the glyphosate pesticide comprises solid glyphosate.

In a further embodiment, the method comprises a step of physically mixing the glyphosate pesticide with the plant growth medium.

In a still further embodiment, the method comprises a step of irrigating the plant growth medium subsequent to application of the glyphosate pesticide.

In an embodiment of the method, the application is carried out prior to sowing the plant growth medium with at least one seed of a plant.

In an embodiment of the method, the application is carried out concurrent with or subsequent to sowing the plant growth medium with at least one seed of a plant.

In an embodiment of the method, the application of the glyphosate pesticide is carried out subsequent to seedling emergence.

In an embodiment of the method, the plant is a Brassicaceae plant.

In an embodiment of the method, the plant is a glyphosate tolerant plant.

In an embodiment of the method, the plant is a glyphosate tolerant canola plant.

In an embodiment of the method, the plant growth medium comprises soil.

In an embodiment of the method, the plant growth medium is comprised within an agricultural field or plot.

A further embodiment is a pesticide composition comprising a glyphosate pesticide for use to prevent, inhibit, reduce, or treat clubroot disease.

In an embodiment the pesticide composition comprises a glyphosate pesticide solution, said solution comprising glyphosate, a glyphosate salt, and/or a derivative of glyphosate that inhibits EPSP synthase; at a total concentration of between about 0.4 mg/ml and about 2.0 mg/ml, between about 0.8 mg/ml and about 1.7 mg/ml, or between 0.82 mg/ml and 1.63 mg/ml.

In an embodiment the pesticide composition is a solid composition.

In an embodiment the pesticide composition comprises at least one additional pesticide or herbicide. In a further embodiment, the at least one additional herbicide comprises a pre-emergent herbicide.

In an embodiment the pesticide composition comprises at least one additional clubroot control agent.

Another embodiment is a plant growth medium pretreated with a glyphosate pesticide.

In an embodiment the plant growth medium pretreated with a glyphosate pesticide is pretreated by application of a glyphosate pesticide to the plant growth medium at an application rate between about 10 g and about 50 g total of glyphosate, a glyphosate salt, and/or a derivative of glyphosate that inhibits EPSP synthase per m² of plant growth medium.

A still further embodiment is a soil treatment composition comprising a glyphosate pesticide.

Yet another embodiment is a method for treating a piece of agricultural equipment to reduce contamination of the equipment by Plasmodiophora brassicae, said method comprising applying a glyphosate pesticide to a surface of the piece of agricultural equipment.

In an embodiment of the method for treating a piece of agricultural equipment, the glyphosate pesticide comprises a solution. In a further embodiment, the solution is sprayed onto the surface of the piece of agricultural equipment. In another embodiment, the piece of agricultural equipment is treated by partial or total immersion within the solution.

In an embodiment of the method for treating a piece of agricultural equipment, the solution comprises about 0.4 mg/ml to about 2.0 mg/ml; about 0.8 mg/ml to about 1.7 mg/ml; or 0.82 mg/ml to 1.63 mg/ml total of glyphosate, a glyphosate salt, and/or a derivative of glyphosate that inhibits APSP.

In an embodiment of the method for treating a piece of agricultural equipment, prior to application of the glyphosate pesticide, the piece of agricultural equipment was exposed to soil and/or plant matter comprising or suspected of comprising a Plasmodiophora species. In a futher embodiment, the Plasmodiophora species is Plasmodiophora brassicae.

Other features and advantages of the present disclosure will become apparent from the following detailed description. It should be understood, however, that the detailed description and the specific examples while indicating preferred embodiments of the disclosure are given by way of illustration only, since various changes and modifications within the spirit and scope of the disclosure will become apparent to those skilled in the art from the detailed description.

### BRIEF DESCRIPTION OF THE DRAWINGS

For a fuller understanding of the nature of the present invention, reference should be had to the following detailed description taken in connection with the accompanying drawings in which:

FIG. 1A is a photograph of 45 day old canola plants (RR hybrid variety VT500G), which were inoculated with 5 ml of Plasmodiophora brassicae spore suspension per plant, at a concentration of 1.0·10⁷ resting spores/ml, at 30 days post seeding.

FIG. 1B is a photograph of 45 day old canola plants (RR hybrid variety VT500G), which were pretreated with glyphosate solution (572 mg glyphosate/350 ml water applied to a 13 cm pot containing 750 cm³ of potting mix) and inoculated with 5 ml of Plasmodiophora brassicae spore suspension per plant, at a concentration of 1.0·10⁷ resting spores/ml, at 30 days post seeding.

FIG. 1C is a photograph comparing the roots of a plant from FIG. 1A and a plant from FIG. 1B, with the plant from FIG. 1A labeled Mock and the plant from FIG. 1B labeled glyphosate.

FIG. 1D is a close-up photograph of the roots of the plants from FIG. 1C.

FIG. 2A is a photograph of 12 day old canola plants (RR hybrid variety VT500G) grown in potting mix heavily infested with resting spores of Plasmodiophora brassicae and pretreated with either water (Mock, 350 ml water in a 13 cm diameter pot containing 750 cm³ of 10 potting mix) or glyphosate solution (143, 286, or 572 mg in 350 ml of water in a 13 cm diameter pot containing 750 cm³ of potting mix) prior to seeding. FIG. 2A is a photograph of the same plants at 22 days post seeding. Some growth retardation is observed on seedlings treated with glyphosate, with plants grown in pots pretreated with a high concentration (572 mg/pot) of glyphosate showing light chlorosis at 12 days post seeding and slightly retarded growth at 22 days post seeding.

FIG. 3A is a photograph of the plants shown in FIGS. 2A and 2B, taken at 35 days post seeding. At this time, canola plants without glyphosate treatment (Mock treated plants) displayed typical foliar symptoms of clubroot disease including stunting, yellowing, and wilting signs. In contrast plants treated with 143 mg, 286 mg, or 572 mg of glyphosate display normal growth.

FIG. 3B is a photograph of the plants shown in FIG. 3A taken at 60 days post seeding. At this time, Mock treated plants showed heavy leaf necrosis and death while plants treated with a low concentration of glyphosate solution (143 mg/pot) appeared less affected, albeit with some signs of early senescence.

FIG. 4 is a photograph of the plants shown in FIG. 3B, taken at 65 days post seeding. At this time, the Mock treated canola plants had died while all glyphosate treated plants had survived. For plants treated with 143 mg/pot of glyphosate solution, abortions of silique development were frequently observed whereas plants treated with higher concentrations of glyphosate solution (286 or 572 mg/pot) displayed normal silique/seed production.

### DETAILED DESCRIPTION OF THE PREFERRED EMBODIMENT

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As used herein the term “about” means that the value or range of values can be greater than or lesser than the stated value or range of values by 10% but is not intended to limit any value or range of values to only this broader definition. Each value or range of values preceded by the term “about” is also intended to encompass the stated absolute value or range of values. Further, any range or series of values is intended to include all individual values encompassed by said range or series. For example a range between 1.0 and 3.2 would include 1.0 and 3.2 as well as any intermediate value, such as 1.2, 1.5, 1.87, 2.3, 3.0, and so forth. A value of at least 2.0 would include 2.0, 2.13, 3.5, and any other value greater than or equal to 2.0.

The term “treat”, “treatment”, or “treating”, as used herein with respect to application of glyphosate, means application of a glyphosate pesticide to a substrate or medium for the purpose of obtaining a beneficial result. The medium may be a plant growth medium. The substrate or medium may comprise or be suspected of comprising a Plasmodiophora species, for example Plasmodiophora brassicae. The substrate or medium may further comprise or be suspected of comprising a soil-borne plant parasite comprising a 5-enolpyruvylshikimate-3-phosphate synthase (EPSP synthase) enzyme. The beneficial result can include, but is not limited to, alleviation or amelioration of one or more symptoms of clubroot disease, prevention of clubroot disease in one or more plants exposed to the substrate or medium, inhibition of clubroot disease, diminishment of the extent of clubroot disease, stabilized (i.e. not worsening) state of clubroot disease, preventing the spread of clubroot disease, delaying or slowing of clubroot disease progression, and amelioration or palliation of clubroot disease.

The term “plant growth medium” as used herein includes any type of plant growth medium, including but not limited to soil, potting mix, sand, soil mix, garden soil, compost, peat moss, sphagnum moss, manure and combinations thereof. Soil types include, for example, sandy soil, silty soil, clay soil, peaty soil, loamy soil, chalky soil, acidic soil, neutral soil, and alkaline soil.

The term “drench application” as used herein refers to application of a liquid solution to a substrate, for example to a plant growth medium, such that the solution penetrates and substantially wets the substrate to a depth of at least 1 cm. Drench application may wet the substrate to a depth greater than 1 cm, for example to a depth of 2 cm, 3 cm, 4 cm, 5 cm, 6 cm, 7 cm, 8 cm, 9 cm, 10 cm, or deeper.

As used herein, the term “glyphosate pesticide” refers to glyphosate, a glyphosate salt, and/or a derivative of glyphosate that inhibits enzyme 5-enolpyruvylshikimate-3-phosphate synthase (EPSP synthase). Salts of glyphosate include, for example, isopropylamine, trimethylsulfonium, diammonium, and potassium salts of glyphosate. The term “glyphosate pesticide” further includes a composition comprising glyphosate, a glyphosate salt, and/or a derivative of glyphosate that inhibits EPSP synthase. The composition may, for example, be a liquid, paste, or solid composition. A solid composition may, for example, be a powdered, caked, or granular composition. In addition to glyphosate, the glyphosate salt, and/or the derivative of glyphosate that inhibits EPSP synthase, the composition may comprise, for example, one or more diluents, fillers, surfactants, carriers, fertilizers, pesticides, and/or herbicides.

Glyphosate, IUPAC name N-(phosphonomethyl)glycine, CAS registry number 1071-83-6, is a widely used post-emergent herbicide. In herbicide compositions, glyphosate is commonly formulated as a salt of the deprotonated acid of glyphosate and a cation. Salt formulations that have been employed include isopropylamine, trimethylsulfonium, diammonium, and potassium (Hess, 1999). Glyphosate herbicide compositions are also commonly formulated to include one or more surfactants, such as ethylated amines, to promote penetration of glyphosate into plant tissues. Under agricultural conditions, the half-life times for glyphosate range from 1-197 days, but are typically less than 60 days (Giesy et al, 2000).

Tradenames for herbicide compositions comprising glyphosate include Roundup®, Rodeo®, Pondmaster®, Gallup®, Landmaster®, Ranger®, and Touchdown®. Traditionally, herbicide compositions comprising glyphosate have been used for weed control by spray application onto plant foliage at a recommended application rate of 0.75 lb (340 g) acid equivalent (a.e.) per acre for post-emergence applications on glyphosate-resistant crops, though application at rates of up to 1.5 lb (680 g) a.e. per acre is common for agricultural use. Glyphosate is tightly bound by soil and has essentially no soil activity. Therefore, glyphosate has been used only as a post-emergence, foliar-applied herbicide (Duke and Powles, 2008). The use of glyphosate has become very widespread since glyphosate-resistant agricultural crops were introduced into the market. The first glyphosate-resistant crop to be commercially available was the glyphosate-resistant soybean which was launched commercially in 1996. Glyphosate-resistant crops that are currently commercially available include alfalfa, canola/rapeseed, corn/maize, cotton, sorghum, soybeans, sugarbeets, and wheat. Adoption of glyphosate-resistant crops has been considerable, with over 90% of all US soybeans, 70% of all US cotton, 75% of US and Canadian canola, and nearly 100% of Argentinian soybeans being glyphosate-resistant varieties. More than 80% of transgenic crops worldwide were glyphosate resistant crops in 2006 (Duke and Powles, 2008). Numerous glyphosate-resistant varieties are available for each crop. For example, commercially available glyphosate-resistant canola varieties include Hyola 400RR, Hyola 404RR, Hyola 500RR, Hyola 505RR, GT Viper, GT Cobra, GT 41, GT 50, Monola513, GT 73, 44Y24 RR, 45Y22 RR, 43Y23 RR, CB Fronteir RR, CB Status RR, Victory V5002RR, VT500G, IH 50 RR, Genuity® canola, GT 73, GT 200, SY4135, and MON 88302.

For weed control, herbicide compositions comprising glyphosate are applied to plants by foliar application, allowing glyphosate to be absorbed by the leaves and stems of the plant. Once absorbed by the plant, glyphosate inhibits the enzyme 5-enolpyruvylshikimate-3-phosphate synthase (EPSP synthase), inhibiting the shikimate pathway and leading to a reduction in the production of the aromatic amino acids phenylalanine, tyrosine, and tryptophan that are required for protein synthesis.

It has now been discovered that glyphosate can be employed as a pesticide for soil treatment. In particular, laboratory experiments have shown that drench application of a glyphosate pesticide solution to potting mix inoculated with spores of Plasmodiophora brassicae reduced the incidence of clubroot disease in glyphosate-resistant canola plants grown in the infested potting mix. While the experiments described below have been carried out using glyphosate-resistant canola plants to assay effectiveness of the treatment, it is expected that pre-treatment of plant growth medium with glyphosate could be carried out prior to sowing of any type of clubroot-susceptible plant, including glyphosate-sensitive plants, provided that when the plant is a glyphosate-sensitive variety, sufficient time is allowed between soil treatment with the glyphosate pesticide and seeding to allow growth of the glyphosate-sensitive plant.

The length of time required between glyphosate herbicide treatment and seeding of a glyphosate-sensitive plant has been shown to vary by soil and plant type and can range from 0 to 21 days or longer. For example, for sunflower seedlings, a waiting time of 7-21 days was found to be effective to eliminate the detrimental effects of glyphosate herbicide application. (Tesfamariam et al, 2009). In another study with winter wheat, 1-2 days was found to be an insufficient waiting time between glyphosate application and seeding, while a 9 day waiting time was found to be sufficient to prevent glyphosate damage (Bott, 2010) In an embodiment of the disclosure, the waiting time between glyphosate pesticide application to plant growth medium and seeding of the plant growth medium may be 0 days, at least 1 day, at least 2 days, at least 3 days, at least 4 days, at least 5 days, at least 6 days, at least 7 days, at least 8 days, at least 9 days, at least 10 days, at least 11 days, at least 12 days, at least 13 days, at least 14 days, at least 15 days, at least 16 days, at least 17 days, at least 18 days, at least 19 days, at least 20 days, at least 21 days, or longer.

In another embodiment, plant growth medium treatment with a glyphosate pesticide could be applied to any type of glyphosate-resistant crop prior to seeding, concurrent with seeding, post-seeding, and/or post-emergence. In an embodiment, the glyphosate-resistant crop is a Brassicaceae crop. This treatment could be carried out as a single application or as a series of applications over time. In an embodiment, the plant growth medium is known to comprise, or is suspected of comprising, a Plasmodiophora species. In a further embodiment, the Plasmodiophora species is Plasmodiophora brassicae.

In an embodiment, a glyphosate pesticide is applied to a plant growth medium as a solution comprising between about 0.4 mg/ml and about 2.0 mg/ml total of glyphosate, a glyphosate salt, and/or a derivative of glyphoase that inhibits EPSP. In another embodiment, the glyphosate pesticide is applied to a plant growth medium as a solution comprising between about 0.8 mg/ml and 1.7 mg/ml total of glyphosate, a glyphosate salt, and/or a derivative of glyphoase that inhibits EPSP. In yet another embodiment, the glyphosate pesticide is applied to a plant growth medium as a solution comprising between 0.82 mg/ml and 1.63 mg/ml total of glyphosate, a glyphosate salt, and/or a derivative of glyphosate that inhibits EPSP.

In another embodiment, a glyphosate pesticide is applied to a plant growth medium at an application rate between at least 0.18 g to at least 1 g/L total of glyphosate, a glyphosate salt, and/or a glyphosate derivative that inhibits EPSP per liter of plant growth medium. For example, the glyphosate pesticide may be applied at a rate of at least 0.18 g/L, at least 0.20 g/L, at least 0.22 g/L, at least 0.24 g/L, at least 0.26 g/L, at least 0.28 g/L, at least 0.30 g/L, at least 0.32 g/L, at least 0.34 g/L, at least 0.36 g/L, at least 0.38 g/L, at least 0.40 g/L, at least 0.42 g/L, at least 0.44 g/L, at least 0.46 g/L, at least 0.48 g/L, at least 0.50 g/L, at least 0.52 g/L, at least 0.54 g/L, at least 0.56 g/L, at least 0.58 g/L, at least 0.60 g/L, at least 0.62 g/L, at least 0.64 g/L, at least 0.66 g/L, at least 0.68 g/L, at least 0.70 g/L, at least 0.72 g/L, at least 0.74 g/L, at least 0.76 g/L, at least 0.78 g/L, at least 0.80 g/L, at least 0.82 g/L, at least 0.84 g/L, at least 0.86 g/L, at least 0.88 g/L, at least 0.90 g/L, at least 0.92 g/L, at least 0.94 g/L, at least 0.96 g/L, at least 0.98 g/L, at least 1.0 g/L or greater of glyphosate, the glyphosate salt, and/or the glyphosate derivative/L of plant growth medium.

In yet another embodiment, a glyphosate pesticide is applied to a plant growth medium at a surface application rate of between about 10 g/m² and about 50 g/m² total, or greater, of glyphosate, glyphosate salt, and/or glyphosate derivative that inhibits EPSP per square meter of plant growth medium. For example, the glyphosate pesticide may be applied at a surface application rate of at least 10 g/m², at least 15 g/m², at least 20 g/m², at least 25 g/m², at least 30 g/m², at least 35 g/m², at least 40 g/m², at least 45 g/m², at least 50 g/m² total, or greater, of glyphosate, glyphosate salt, and/or glyphosate derivative /m² of plant growth medium.

While the experiments described below have been carried out using drench application of a liquid glyphosate pesticide to a plant growth medium, in another embodiment treatment of the plant growth medium may be accomplished by application of a solid glyphosate pesticide to the plant growth medium. In an embodiment, the plant growth medium is known to comprise, or is suspected of comprising, a Plasmodiophora species. In a further embodiment, the Plasmodiophora species is Plasmodiophora brassicae.

In an embodiment, for example, a granular glyphosate pesticide may be applied to the surface of a plant growth medium and/or mixed with a plant growth medium to incorporate the glyphosate pesticide into the plant growth medium. Application of the glyphosate pesticide may be carried out prior to seeding, concurrent with seeding, post-seeding, and/or post-emergence.

In an embodiment, a glyphosate pesticide is applied to a plant growth medium in a single application while in another embodiment, the glyphosate pesticide may be applied to a plant growth medium in a series of applications over time. In yet another embodiment, dispersal of the glyphosate pesticide through the plant growth medium may be aided by irrigating the plant growth medium subsequent to the application of the glyphosate pesticide to the plant growth medium.

In an embodiment, a glyphosate pesticide is applied to soil in an agricultural field or plot, with the application of the glyphosate pesticide being carried out prior to seeding, concurrent with seeding, post-seeding, and/or post-emergence. The term “agricultural plot” includes, but is not limited to, a plot of land or a bed, such as a garden or raised bed, used to grow a plant or crop which may optionally be encased within a greenhouse or other structure. In another embodiment, the glyphosate pesticide may be applied to a plant growth medium comprised within a plant growth container, such as a pot or tray.

A further embodiment is a plant growth medium pre-treated with a glyphosate pesticide. For example, a glyphosate pesticide may be mixed with a plant growth medium to pre-treat the plant growth medium prior to use to grow one or more plants. In an embodiment, the glyphosate pesticide may be mixed with a plant growth medium before packaging the plant growth medium for distribution or sale. A further embodiment is a plant growth medium comprising a glyphosate pesticide.

Yet another embodiment is a pesticide composition comprising a glyphosate pesticide together with at least one other pesticide and/or herbicide. In an embodiment, the at least one other pesticide or herbicide comprises a pre-emergent herbicide.

A further embodiment is a pesticide composition comprising a glyphosate pesticide together with at least one additional clubroot control agent. Numerous clubroot control agents will be readily apparent to one skilled in the art. For example the at least one additional clubroot control agent may comprise a biocontrol agent such as Bacillus subtilis, Gliocladium catenulatum, Trichoderma spp., Streptomyces spp., or Gliocladium catenulatum; a fungicide such as fluazinam, cyzofamid, sodium methyldithiocarbamate or pentachloronitrobenzene; a chemical control agent such as hydrogen cyanamide, calcium cyanimide, mercuric chloride, boron, lime, or chitosan; or a surfactant such as sodium dioctyl sulphosuccinate, alkyl phenyl ethylene oxide, Renex™, Induce™, or ASPA 80™.

In another embodiment, a glyphosate pesticide may be used to treat agricultural equipment to reduce the spread or dispersal of Plasmodiophora brassicae on said agricultural equipment. The term “agricultural equipment” is intended to include any type of object or equipment that may come into contact with a plant or plant growth medium, such as tillage equipment, sowing equipment, harvest equipment, pesticide application equipment, cutting tools, personal protective gear, and footwear. For example, agricultural equipment that has come into contact with plants and/or plant growth medium potentially infected with Plasmodiophora brassicae may be treated with the glyphosate pesticide prior to use in another area in order to reduce the spread of the pathogen from one area to another. As an example, a surface of a piece of agricultural equipment, such as tillage or harvest equipment that is in contact with plants or soil, may be sprayed with and/or immersed in a glyphosate pesticide solution between uses in order to reduce the spread of pathogen carried by the equipment. The immersion time may range from less than a minute to an hour or more. Spraying should be carried out to substantially wet the surface to be treated.

In a further embodiment, a glyphosate pesticide is applied to a piece of agricultural equipment subsequent to exposure of the equipment to plant material and/or a plant growth medium comprising or suspected of comprising Plasmodiophora brassicae. In an embodiment the glyphosate pesticide may be applied as a solution having a concentration of between about 0.4 mg/ml and about 2.0 mg/ml total of glyphosate, a glyphosate salt, and/or a glyphosate derivative/ml of solution. In another embodiment, the glyphosate pesticide is applied as a solution comprising between about 0.8 mg/ml and about 1.7 mg/ml total of glyphosate, a glyphosate salt, and/or a glyphosate derivative/ml of solution. In yet another embodiment, the glyphosate pesticide is applied as a solution comprising between 0.82 mg/ml and 1.63 mg/ml total of glyphosate, a glyphosate salt, and/or a glyphosate derivative per ml of solution.

### EXAMPLES

Some embodiments of the present invention are further described with reference to the following examples, which are meant to be illustrative and not restrictive in nature.

### Example 1

### Isolation of Plasmodiophora brassicae

An isolate of clubroot pathogen Plasmodiophora brassicae was obtained from infested canola fields in central Alberta. The pathogen population from this collection may represent a mixture of pathotypes, but pathotype 3 is expected to be predominant (Peng et al., 2011). The inoculum was propagated using a susceptible canola cv. Westar grown in the infested soil with spores. Fresh clubroot galls were harvested, air dried, and stored at 4° C., and were further used for fresh inoculum preparation. To extract spores, 2-5 g of air-dried galls were soaked in distilled water for a few hours to soften the tissues and then ground in a mortar with pestle. The resulting slurry was filtered through three layers of cheesecloth and the spore concentration was estimated under a microscope. Inoculum concentration of 1.0·10⁷ resting spores/ml was used for inoculation.

### Example 2

### Treatment of Canola Seedlings

### Materials and Methods

Canola plants, cultivar Westar and the glyphosate-resistant transgenic line VT500G of Brassica napus, were used. Plants were grown in a phytotron at 22° C. with a light/dark photoperiod of 16 h/8 h (light intensity 120 μmol m⁻² s⁻¹).

Canola seeds were sown in sterile potting mix consisting of fine peat moss, vermiculite, gypsum, dolomitic limestone and starter nutrient (Sunshine Mix #3; pH 5.8-6.2; Sun Gro Horticulture Canada Ltd., Canada) in 13 cm diameter plastic pots containing 750 cm³ of potting mix [approximate volume of soil per pot=750 ML (CM³)]. The plants were grown for thirty days at 22° C. with 16 h photoperiod in a growth chamber and watered by tap water. Twenty day-old of canola plants were treated with glyphosate solution (glyphosate (MONSANTO CANADA INC.)) as follows. The potting mix with canola plants was irrigated with the glyphosate solution at an application rate of 143, 286, or 572 mg of glyphosate in 350 ml of water in a 13 cm diameter pot filled with potting mix. These application rates are roughly equivalent to 0.19 g/L, 0.38 g/L, and 0.76 g/L of glyphosate/L of potting mix respectively. The incubated plants were allowed to continue to grow for one day and then inoculated with P. brassicae spores, isolated as described in Example 1, by watering the roots with 5 ml of spore suspension per plant, at a concentration of 1.0·10⁷ resting spores/ml. The plants were then allowed to grow for 15 days post-inoculation and examined for growth phenotypes and clubroot symptom development.

### Results

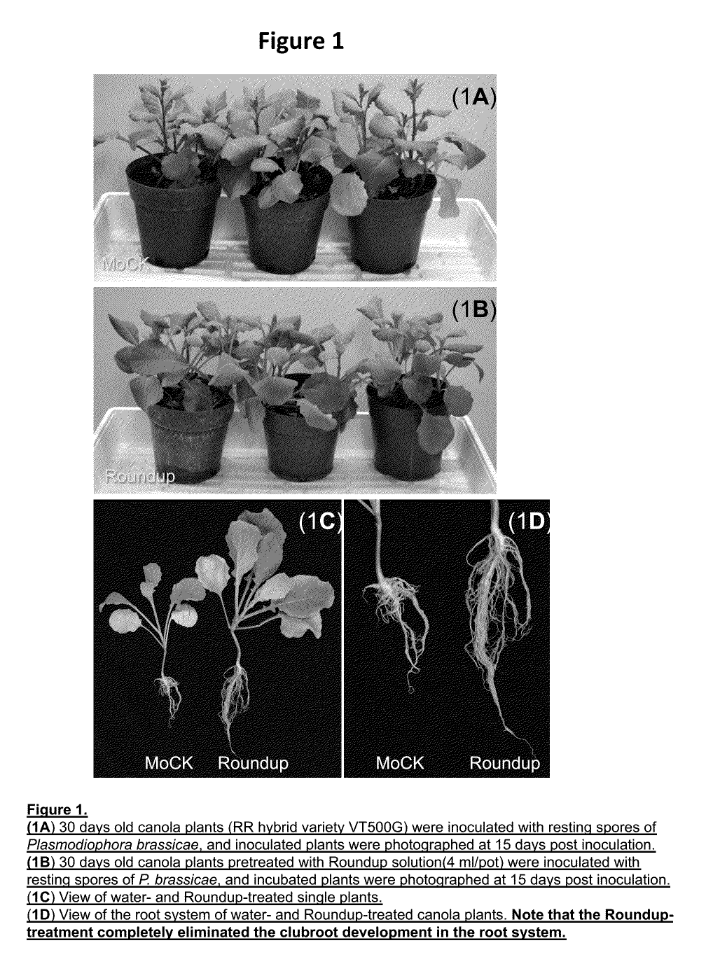

Plants were photographed at 15 days post-inoculation shown in FIGS. 1A, 1B, 1C and 1D, with FIG. 1A representing a mock treatment and FIG. 1B representing treatment with 572 mg/pot of glyphosate of glyphosate. As shown in FIGS. 1C and 1D, treatment with glyphosate (572 mg/pot glyphosate) prevented visible clubroot development in the root system of treated plants.

### Example 3

### Pre-Seeding Treatment of Soil

### Materials and Methods

Canola plants, cultivar Westar and the Roundup®-resistant transgenic line VT500G of Brassica napus, were used. Plants were grown in a phytotron at 22° C. with a light/dark photoperiod of 16 h/8 h (light intensity 120 μmol m⁻² s⁻¹).

Potting mix consisting of fine peat moss, vermiculite, gypsum, dolomitic limestone and starter nutrient (Sunshine Mix #3; pH 5.8-6.2; Sun Gro Horticulture Canada Ltd., Canada) in 13 cm diameter plastic pots was inoculated with P. brassicae spores. The P. brassicae infested potting soil was then irrigated with 350 ml of water or glyphosate (Roundup®, Monsanto Canada Inc.) solution to provide an application rate of 0 mg, 143, 286, or 572 mg of glyphosate per 13 cm pot containing 750 cm₃ of potting mix. VT500G canola seeds were subsequently sown on the treated potting mix and allowed to grow at 22° C. with a light/dark photoperiod of 16 h/8 h for 65 days. Plant growth and clubroot symptom development were monitored over the incubation time course.

### Results

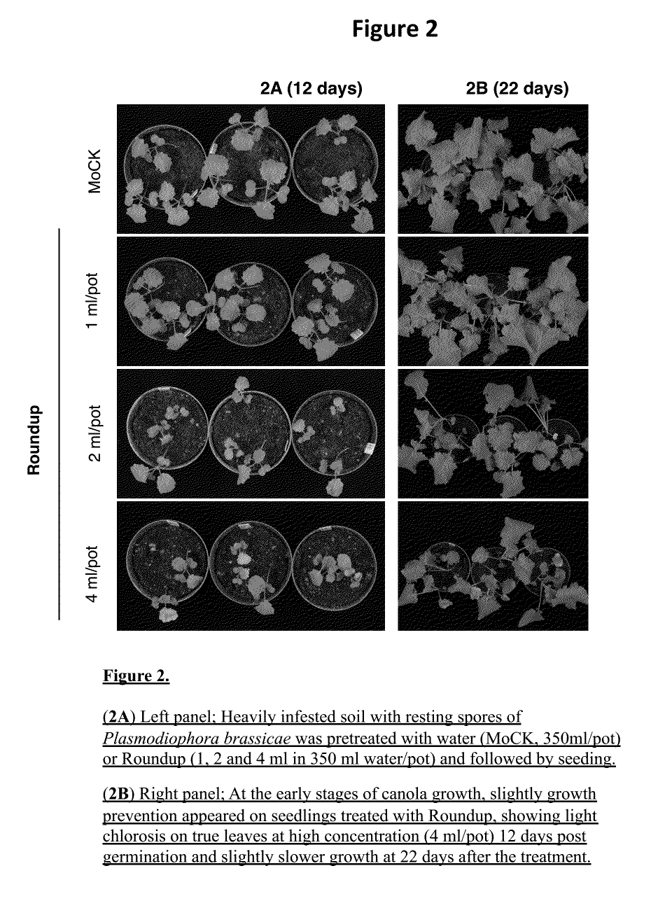

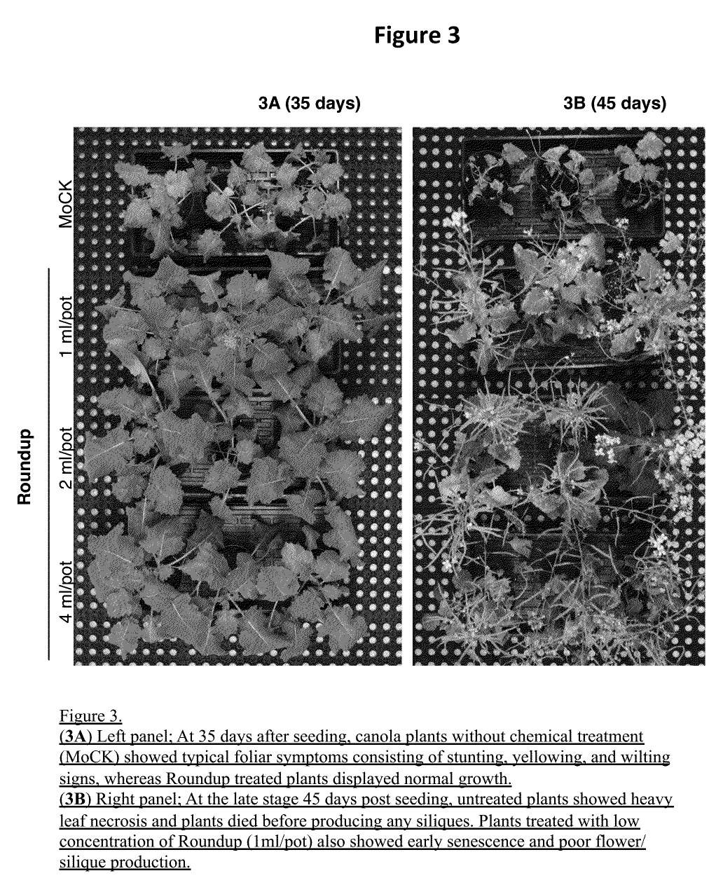

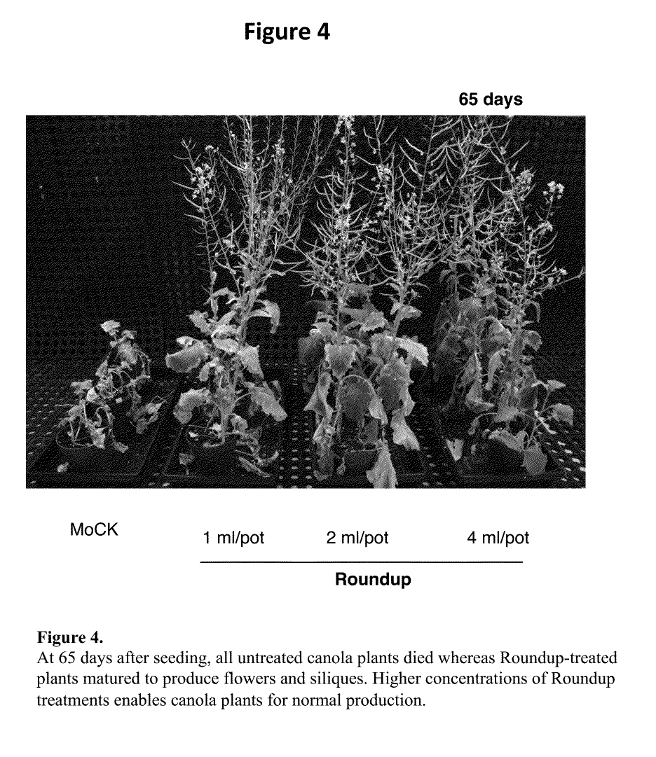

Plants were observed at 12, 22, 35, 60, and 65 days post seeding. At the early stages, some growth impediment was observed for seedlings treated with glyphosate, showing light chlorosis on true leaves in plants grown in potting mix treated with a high concentration (572 mg/pot) of glyphosate at 12 days post seeding and showing slightly retarded growth at 22 days post seeding (FIGS. 2A and 2B). At 60 days post seeding, mock treated plants showed heavy leaf necrosis and death. Plants treated with a low concentration of glyphosate (143 mg/pot) showed an early senescence, while plants treated with 286 mg/pot or 572 mg/pot of glyphosate did not display early senescence. At 65 days post seeding, the mock treated canola plants died. However, all glyphosate-treated plants survived and were maturing for flower and silique production. Abortions of silique development were frequently observed on canola plants treated with a low concentration of glyphosate (143 mg/pot), whereas treatments with higher concentrations (286 mg/pot or 572 mg/pot) enabled normal silique/seed production.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments.

Further, while the above description provides examples of the embodiments, it will be appreciated that some features and/or functions of the described embodiments are susceptible to modification. Accordingly, what has been described above has been intended to be illustrative of the invention and non-limiting. The scope of the claims should not be limited by the specific embodiments set forth in the examples, but should instead be given the broadest interpretation consistent with the specification as a whole.

### REFERENCES CITED

Bott S. (2010), Rhizosphere processes as determinants for glyphosate damage of non-target plants, Ph.D. Thesis, Faculty of Agricultural Sciences at the University of Hohenheim

Crete R. (1981), Worldwide importance of clubroot [Brassica], Clubroot Newsletter 11:6-7.

Diederichsen E., Frauen M., Linders E. G. A., Hatakeyama K., and Hirai M. (2009), Status and Perspecctives of Clubroot Resistance Breeding in Crucifer Crops, Journal of Plant Growth Regulation 28: 265-281.

Dixon G. R. (2009), The Occurrence and Economic Impact of Plasmodiophora brassicae and Clubroot Disease, Journal of Plant Growth Regulation 28: 194-202.

Duke S. O. and Powles S. B. (2008), Glyphosate: a once-in-a-century herbicide, Pest Management Science 64:319-325.

Giesy J. P., Dobson S., and Solomon K. R. (2000), Ecotoxicological risk assessment for Roundup® herbicide. Reviews of Environmental Contamination and Toxicology, 167: 35-120.

Hess D. F. (1999), Inhibitors of aromatic amino acid biosynthesis (glyphosate). Herbicide Action: An intensive course of activity, selectivity, behavior, and fate of herbicides in plants and the environment, p. 440-454, Purdue University, West Lafayette, Ind.

Hirai M. (2006), Genetic Analysis of Clubroot Resistance in Brassica crops, Breeding Science 56: 223-229.

Howard R. J., Strelkov S. E., and Harding M. W. (2010), Clubroot of cruciferous crops—new perspectives on an old disease, Canadian Journal of Plant Pathology 32:1, 43-57.

Myers, D F and Campbell R. N. (1985), Lime and the control of clubroot of Crucifers: Effects of pH, Calcium, Magnesium, and their interactions, The American Phytopathological Society 75: 670-673.

Oxley S. (2007), Clubroot Disease of Oilseed Rape and other Brassica Crops, Edinburgh, UK: Scottish Agriculture College: Technical Note, TN 620.

Peng, G., McGregor, L., Lahlali, R., Gossen, B. D., Hwang, S. F., Adhikari, K. K., Strelkov, S. E. and McDonald, M. R. (2011), Potential biological control of clubroot on canola and crucifer vegetable crops. Plant Pathology 60(3):566-574.

Roberts F., Roberts C. W., Johnson J. J., Kyle D. E., Krell T., Coggins J. R., Coombs G. H., Milhous W. K., Tzipori S., Ferguson D. J. P., Chakrabarti D., and McLeod R. (1998), Evidence for the shikimate pathway in apicomplexan parasites, Nature 393: 801-805.

Strelkov S. E., Tewari J. P., and Smith-Degenhardt E. (2006), Characterization of Plasmodiophora brassicae populations from Alberta, Canada, Canadian Journal of Plant Pathology 28: 467-5 474.

Tesfamariam T., Bott S., Cakmak I., Romheld V., and Neumann G. (2009), Glyphosate in the rhizosphere—Role of waiting times and different glyphosate binding forms in soils for phytotoxicity to non-target plants, European Journal of Agronomy, 31: 126-132.

Wallenhammar A. -C. (1996), Prevalence of Plasmodiophora brassicae in a spring oilseed rape growing area in central Sweden and factors influencing soil infestation levels, Plant Pathology 45: 710-719.

What is claimed is:

1. A method for treating a plant growth medium, said method comprising applying a glyphosate pesticide to said plant growth medium in order to prevent, inhibit, reduce, or treat clubroot disease in one or more plants grown in said plant growth medium.

2. The method of claim 1, wherein the glyphosate pesticide comprises a solution comprising glyphosate, a glyphosate salt, and/or a derivative of glyphosate that inhibits enzyme 5-enolpyruvylshikimate-3-phosphate synthase (EPSP synthase).

3. The method of claim 2, wherein the solution comprises the glyphosate, the glyphosate salt, and/or the glyphosate derivative at a total concentration of between about 0.4 mg/ml and about 2.0 mg/ml, between about 0.8 and about 1.7 mg/ml, or between 0.82 mg/ml and 1.63 mg/ml.

4. The method of claim 2 or 3, wherein the application of the solution to the plant growth medium is carried out by drench application.

5. The method of any one of claims 1 to 4, wherein the glyphosate pesticide is applied to the plant growth medium at an application rate of between about 0.18 g to about 1 g total of glyphosate, glyphosate salt, and/or glyphosate derivative per liter of plant growth medium.

6. The method of any one of claims 1 to 5, wherein the glyphosate pesticide is applied to the plant growth medium at a surface application rate of between about 10 g to about 50 g total of glyphosate, glyphosate salt, and/or glyphosate derivative per m² of plant growth medium.

7. The method of any one of claim 1, 5, or 6 wherein the glyphosate pesticide comprises solid glyphosate.

8. The method of claim 7, further comprising a step of physically mixing the glyphosate pesticide with the plant growth medium.

9. The method of claim 7 or 8, further comprising a step of irrigating the plant growth medium subsequent to application of the glyphosate pesticide.

10. The method of any one of claims 1 to 9, wherein the application is carried out prior to sowing the plant growth medium with at least one seed of a plant.

11. The method of any one of claims 1 to 9, wherein the application is carried out concurrent with or subsequent to sowing the plant growth medium with at least one seed of a plant.

12. The method of claim 11, wherein the application of the glyphosate pesticide is carried out subsequent to seedling emergence.

13. The method of any one of claims 10 to 12, wherein the plant is a Brassicaceae plant.

14. The method of any one of claims 10 to 13, wherein the plant is a glyphosate tolerant plant.

15. The method of claim 14, wherein the plant is a glyphosate tolerant canola plant.

16. The method of any one of claims 1 to 15, wherein the plant growth medium comprises soil.

17. The method of any one of claims 1 to 16, wherein the plant growth medium is comprised within an agricultural field or plot.

18. A pesticide composition comprising a glyphosate pesticide for use to prevent, inhibit, 15 reduce, or treat clubroot disease.

19. The pesticide composition of claim 18, comprising a glyphosate pesticide solution, said solution comprising glyphosate, a glyphosate salt, and/or a derivative of glyphosate that inhibits EPSP synthase; at a total concentration of between about 0.4 mg/ml and about 2.0 mg/ml, between about 0.8 mg/ml and about 1.7 mg/ml, or between 0.82 mg/ml and 1.63 mg/ml.

20. The pesticide composition of claim 18, wherein said composition is a solid composition.

21. The pesticide composition of any one of claims 18-20, further comprising at least one additional pesticide or herbicide.

22. The pesticide composition of claim 21, wherein the at least one additional herbicide comprises a pre-emergent herbicide.

23. The pesticide composition of any one of claims 18-20, further comprising at least one additional clubroot control agent.

24. A plant growth medium pretreated with a glyphosate pesticide.

25. The plant growth medium of claim 24, wherein the plant growth medium is pretreated by application of a glyphosate pesticide to the plant growth medium at an application rate between about 10 g and about 50 g total of glyphosate, a glyphosate salt, and/or a derivative of glyphosate that inhibits EPSP synthase per m² of plant growth medium.

26. A soil treatment composition comprising a glyphosate pesticide.

27. A method for treating a piece of agricultural equipment to reduce contamination of the equipment by Plasmodiophora brassicae, said method comprising applying a glyphosate pesticide to a surface of the piece of agricultural equipment.

28. The method of claim 27, wherein the glyphosate pesticide comprises a solution.

29. The method of claim 28, wherein the solution is sprayed onto the surface of the piece of agricultural equipment.

30. The method of claim 28, wherein the piece of agricultural equipment is treated by partial or total immersion within the solution.

31. The method of any one of claims 28 to 30, wherein the solution comprises about 0.4 mg/ml to about 2.0 mg/ml; about 0.8 mg/ml to about 1.7 mg/ml; or 0.82 mg/ml to 1.63 mg/ml total of glyphosate, a glyphosate salt, and/or a derivative of glyphosate that inhibits APSP.

32. The method of any one of claims 27 to 31, wherein prior to application of the glyphosate pesticide, the piece of agricultural equipment was exposed to soil and/or plant matter comprising or suspected of comprising a Plasmodiophora species.

33. The medthod of claim 32, wherein the Plasmodiophora species is Plasmodiophora brassicae.
